(19) United States
(12) Patent Application Publication
(10) Pub. No.: US 2006/0032593 A1
(43) Pub. Date: Feb. 16, 2006

(54) Cloth venetian blind

(75) Inventor: Ming Nien, Taichung (TW)

Correspondence Address: TROXELL LAW OFFICE PLLC;SUITE 1404, 5205 LEESBURG PIKE, FALLS CHURCH, VA, 22041, US

(73) Assignee: Nien Made Enterprise Co., Ltd.

(21) Appl. No.: 10/900,295

(22) Filed: Jul. 28, 2004

(51) Int. Cl. E06B 9/30

(52) U.S. Cl. 160/168.1 R

(57) ABSTRACT

A cloth Venetian blind includes a winding cylinder, a plurality of cloth slats, at least two fixing ropes and a plurality of slat support rods. The cloth slats are arranged under the winding cylinder in parallel, respectively having two long sides and two short sides. The fixing ropes have an upper end fixed on the winding cylinder, extending down vertically through the two long sides of each cloth slat, and also provided with a rope ring at a location under the long sides of each cloth slat for each slat support rod to pass through horizontally securely so as to prop up the relative one of the cloth slats.

### BACKGROUND OF THE INVENTION

1. Field of the Invention

This invention relates to a cloth Venetian blind, particularly to one provided with fixing ropes with rope rings, a plurality of cloth slats respectively having its two long sides, with the string rings located under the long sides for slat support rods to pass through and kept securely in place so that each cloth slat may be propped up in place by the slat support rods.

2. Description of the Prior Art

A conventional cloth Venetian blind disclosed in a U.S. Pat. No. 6,105,657 includes a plurality of cloth slats, several connecting ladder-style ropes or bands, a winding cylinder, a lower rod and at least a pull rope. The winding cylinder is positioned at an upper side of a window frame, and the lower support rod is positioned at the bottom of the cloth slats, which are arranged parallel between the winding cylinder and the lower support rod. The connecting ropes or bands are connected with the two long sides and the bottom of each cloth slats for keep the cloth stats in position. The pull rope is fixed with the lower rod and then can be pulled it up so that the cloth slats all may be pulled up to overlap with each other. Further, a band-shaped intermediate cloth is added to each cloth slat to form a bag between them for each support rod to be contained therein for propping up the two long sides of each cloth slat.

However, the conventional cloth Venetian blind in the US patent has the connecting ropes respectively limit the two long sides and the bottom of each cloth slat, impossible to secure the short sides of each cloth slat. Therefore, when the cloth slats are inclined, the soft cloth slats may incline from the upper side to the lower side, forcing the cloth slats to become wrinkled to worsen their appearance. Besides, when the cloth slats are blown by a wind, their long sides may be apt to flap reversely, and may be wrinkled or damaged more or less after a period of use. In addition, the support rods are respectively received in the bag, but not kept securely in position with any means. So the support rods may protrude out of the bags after a period of use, affecting the appearance of the cloth slats.

### SUMMARY OF THE INVENTION

This invention has been devised to offer a cloth Venetian blind, which includes a winding cylinder, a plurality of cloth slats, at least two fixing ropes and a plurality of slat support rods. The cloth slats are positioned parallel below the winding cylinder, respectively having two long sides and two short sides. The fixing ropes respectively extend down from the winding cylinder through the two opposite locations of each long side of each cloth slat, and has a rope ring under the two long sides for each slat support rod to pass through and be secured at the position for propping up respectively a related cloth slat.

The slat support rods really support all of the cloth slats in the cloth Venetian blind in the present invention, at the two long sides of each cloths slat without possibility of the slat support rods sliding in the lengthwise direction of the cloth slats. Moreover, the slat support rods can force the cloth slats spread in the long sides, preventing them from forming any wrinkles so as to keep them in a neat appearance of the flat condition.

### BRIEF DESCRIPTION OF DRAWINGS

This invention will be better understood by referring to the accompanying drawings, wherein:

FIG. 1 is a perspective view of a first embodiment of a cloth Venetian blind in the present invention;

FIG. 2 is a side view of the first embodiment of a cloth Venetian blind in the present invention;

FIG. 3 is a partial perspective view of the first embodiment of a cloth Venetian blind in the present invention;

FIG. 4 is a partial side view of the first embodiment of a cloth Venetian blind in the present invention;

FIG. 5 is a side view of the first embodiment of a cloth Venetian blind being inclined in the present invention;

FIG. 6 is a partial side view of a second embodiment of a cloth Venetian blind in the present invention; and,

FIG. 7 is a partial perspective view of a third embodiment of a cloth Venetian blind in the present invention.

### DETAILED DESCRIPTION OF THE PREFERRED EMBODIMENTS

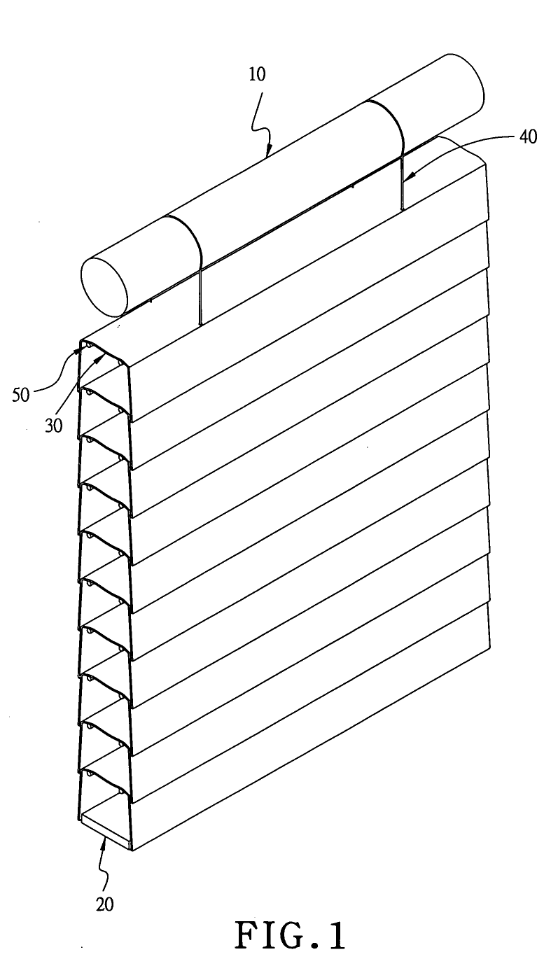

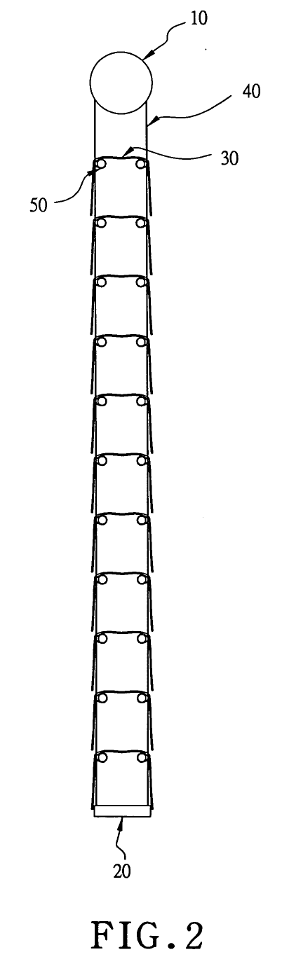

A first embodiment of a cloth Venetian blind in the present invention, as shown in FIGS. 1 and 2, includes a winding cylinder 10, a lower rod 20, a plurality of cloth slats 30, four fixing ropes 40 and a plurality of slat support rods 50 as main components combined together.

The winding cylinder 10 is positioned at an upper end of the cloth Venetian blind, possible to be rotated freely.

The lower support rod 20 is positioned at the lower end of the cloth Venetian blind.

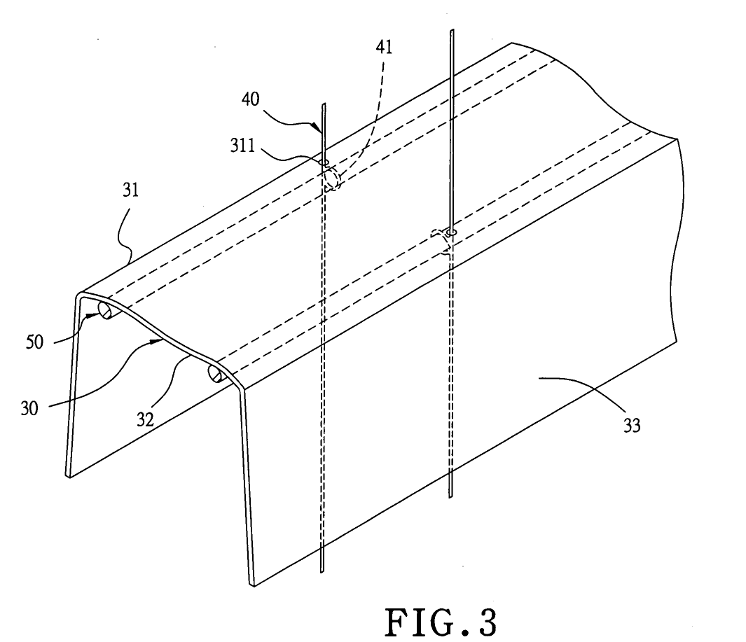

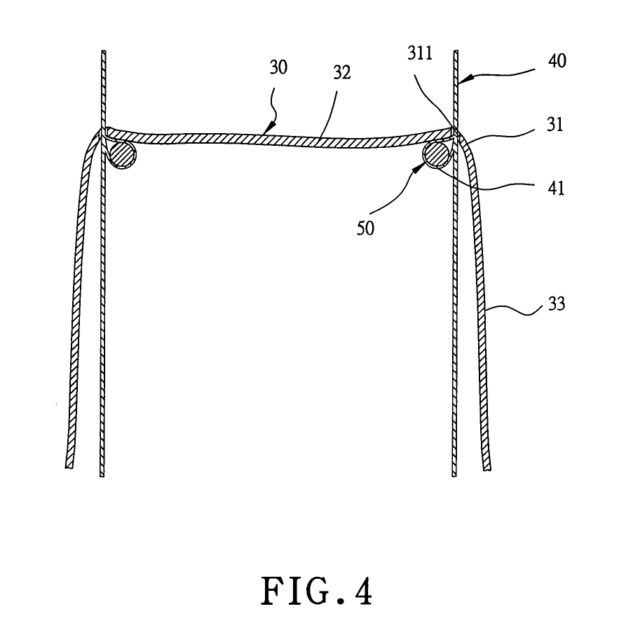

The plurality of cloth slats 30, as shown in FIGS. 3 and 4, are positioned parallel and spaced apart equidistantly between the winding cylinder 10 and the lower rod 20, respectively having two lengthwise long sides 31 and two lateral short sides 32. Further, each long side 31 has two rope holes 311 spaced apart properly, and a curtain strip 33 is connected with each long side 31, handing down.

The fixing ropes 40 are fixed at their upper end on the winding cylinder 10, extending down through the rope holes 311 of each cloth slat 30 and fixed firmly with the lower rod 20 at their lower end. Further, each fixing rope 40 has a rope ring 41 at a location under each long side 31 of the cloth slat 30,

The slat support rods 50 are positioned parallel to the long sides 31 of the cloth slats 30, passing through the rope rings 41 of the fixing rope 40, propping up relative cloth slats 30.

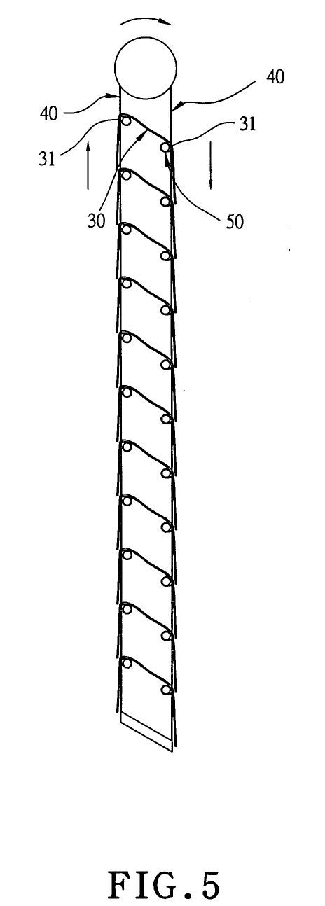

Next, as shown in FIGS. 2 and 5, the cloth slats 30 can be inclined in their angle for controlling light shutting percentage of the Venetian blind. The handling method is to pull down one side of each fixing rope 40 and let the other side of the same fixing rope 40 move up so that all of the cloth slats 30 may be inclined to one side, with the slat support rods 50 on one side pulled down and those 50 on the other side moved up so as to let the cloth slats 30 inclined to one side for a certain angle. Therefore, if the distance of the pulling-down of the cloth slats 30 is controlled or adjusted, then the inclined angle of them can be changed to adjust the light shutting percentage of the Venetian blind.

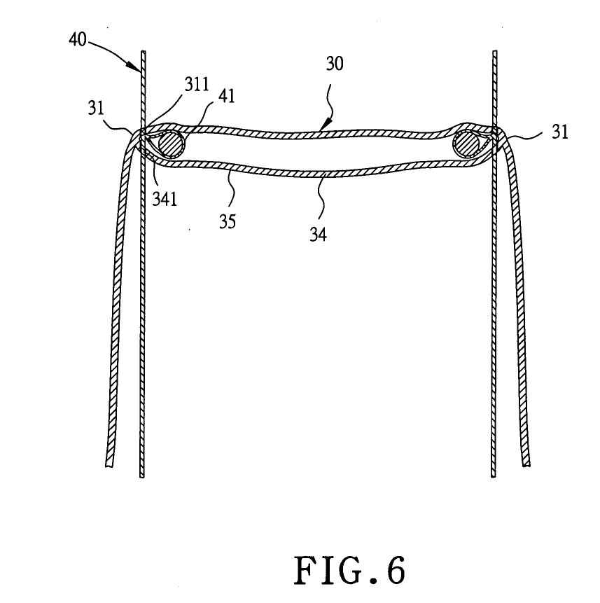

Moreover, FIG. 6 shows a second embodiment of a cloth Venetian blind in the invention, which a lower cloth slat 34 is added under each cloth slat 30 in the first embodiment, having the same size as the cloth slat 30 and two lengthwise long sides connected with the two long sides 31 so as to form a bag 35 between the cloth slat 30 and the lower cloth slat 34. Further, the lower cloth slat 34 is also provided with a rope hole 341 to correspond to the rope hole 311 of the cloth slat 30 for the fixing rope 40 to pass through and then fixed with the lower rod 20. Further, the rope rings 41 of the fixing ropes 40 are respectively positioned in the bags 35.

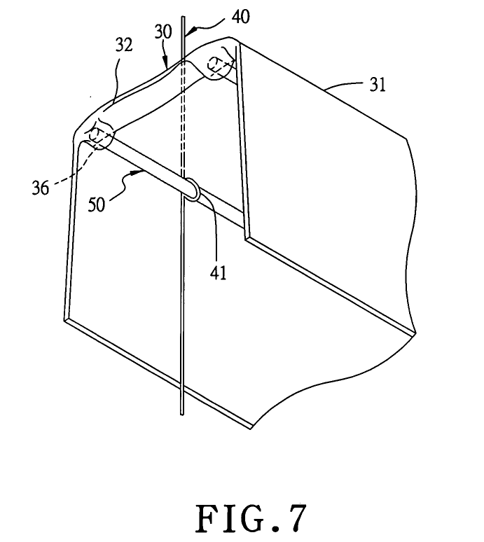

Next, FIG. 7 shows a third embodiment of a cloth Venetian blind in the invention, which in the first embodiment a pocket 36 is respectively added by means of sawing at each lower corner of each short sides 32 of the cloth slats 30, extending in the direction of the long sides 31 and opening to the inside. Then the two ends of each slat support rods 50 can be inserted in the pockets 36 so as to let the rod 50 limited securely in position and propping up the cloth slats 30.

The cloth Venetian blind in the invention has the following advantages.

1. The cloth slats 30 can be kept neat and flat by tension of the fixing ropes 40, as the two long sides 31 of each cloth slat 30 is supported in place by the slat support rods 50, which are kept in place by means of the rope rings 41. So even if the cloth slats 30 are blown by a wind to incline to one side, there may not arise wrinkles to the cloth slats 30, or cause any damage to them. Therefore, the cloth Venetian blind in the invention can be used for long with its appearance not worsened.

2. The slat support rods 50 has a secure position function for the cloth slats 30, because the slat support rods 50 are retained by the rope rings 41 in place, and then inserted in the pockets 36 of the short sides 32. Therefore, the slat support rods 50 do not have the same drawbacks of the slat support rods protruding out of the bags in the conventional cloth Venetian blind.

While the preferred embodiments of the invention have been described above, it will be recognized and understood that various modifications may be made therein and the appended claims are intended to cover all such modifications that may fall within the spirit and scope of the invention.

What is claimed is:

1. A cloth Venetian blind comprising:
A winding cylinder positioned at an upper end of said cloth Venetian blind and possible to be rotated feely:
A plurality of cloth slats positioned in parallel to and below said winding cylinder, each said cloth slat having two lengthwise long sides and two lateral short sides:
At least two fixing ropes respectively having an upper end fixed on said winding cylinder and extending vertically down to pass through said two long sides of each said cloth slat so that each said cloth slat may be positioned in its place, said fixing ropes respectively having a rope ring under two opposite locations of said two long sides of each said cloth slat: and,
A plurality of slat support rods respectively positioned in parallel to and under each said long side of each cloth slat and passing through each said rope ring in a secured condition, each said slat support rod propping up each said cloth slat relative to itself.

2. The cloth Venetian blind as claimed in claim 1, wherein a lower cloth slat is further provided under each said cloth slat, having the same size as said cloth slat and two lengthwise long sides connected with said two long sides of each said cloth slat so that a bag is formed between said lower cloth slat and said cloth slat for each said slat support rod to be received in each said bag.

3. The cloth Venetian blind as claimed in claim 1, wherein a pocket is formed in parallel to said long sides and opens to an inner side respectively at each lower corner of said two short sides of each said cloth slat, and two ends of each said slat support rod are respectively inserted in said two pockets of each said short side in that limited position.

4. The cloth Venetian blind as claimed in claim 1, wherein each said cloth slat is provided with a rope hole at a location corresponding to each said fixing rope for the same rope to pass through and to be kept at a constant position.

5. The cloth Venetian blind as claimed in claim 1, wherein a curtain strip is connected respectably with each said long side of each said cloth slat and hangs down.

6. The cloth Venetian blind as claimed in claim 1, wherein a lower cloth slat is added under each said cloth slat, having the same size as each said cloth slat and two lengthwise long sides connected respectively with said two long sides of each said cloth slat so that a bag is formed between each said cloth slat and said lower cloth slat for each said slat support rod to be contained therein, and each said long side of each said cloth slat is provided with a rope hole for each said fixing rope to pass through and to be kept securely in place.

7. The cloth Venetian blind as claimed in claim 1, wherein a pocked parallel to said long sides of each said cloth slat and having an inward opening is respectively provided at each lower corner of each said short side of each said cloth slat, said pockets receive respectively two ends of each said slat support rod to keep it securely in place, and a rope hole is provided respectively in each said long side at a location corresponding to each said fixing rope for said fixing rope to pass through and to be kept in place.

8. The cloth Venetian blind as claimed in claim 1, wherein a lower cloth slat is further added under each said cloth slat, having the same size as each said cloth slat and two lengthwise long sides connected with said two long sides of each said cloth slat so that a bag is formed between each said cloth slat and each said lower cloth slat for receiving each said slat support rod therein, and a curtain strip is connected respectively with each said long side of each said cloth slat and hangs down.

9. The cloth Venetian blind as claimed in claim 1, wherein a pocket parallel to said long sides of each said cloth slat and having an inward opening is provided respectively at each lower corner of each said short side of each said cloth slat so that two ends of each said slat support rod may be received in said two pockets and kept in place, and a curtain strip is connected respectively with each said long side of each said cloth slat and hangs down.
